(19) United States
(12) Patent Application Publication
(10) Pub. No.: US 2024/0074404 A1
(43) Pub. Date: Mar. 7, 2024

(54) Canine Portable Bathroom Pad Device And Method

(71) Applicants: Karen Brice, Fort Worth, TX (US); Treasure Foreman, Fort Worth, TX (US); Chance Brice, Fort Worth, TX (US)

(72) Inventors: Karen Brice, Fort Worth, TX (US); Treasure Foreman, Fort Worth, TX (US); Chance Brice, Fort Worth, TX (US)

(21) Appl. No.: 17/902,850

(22) Filed: Sep. 4, 2022

(51) Int. Cl. A01K 1/015

(52) U.S. Cl. CPC A01K 1/0157

(57) ABSTRACT

A canine portable bathroom pad device and method for being a canine bathroom pad includes a base being a quilted pad. The base has a top surface, a bottom surface, and a ring positioned on a perimeter edge of the base. The ring is hollow and has a pair of openings to an interior of the ring. Furthermore, a strip is positioned on the bottom surface of the base and is an adhesive material. A strap is nested within the ring of the base and is positioned within each of the openings thus defining a pair of grips.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to portable trash device and more particularly pertains to a new portable trash device for being a canine bathroom pad.

### (2) Description of Related Art Including Information Disclosed Under 37 CFR 1.97 and 1.98

The prior art relates to portable trash devices. The prior art includes a variety of portable trash devices comprising a strap used to enclose the trash within the device. Furthermore, the prior art relates to a variety of portable trash devices configured for removing canine waste. Known prior art lacks a portable trash device comprising an adhesive strip to retain the device to the ground when in use prior to enclosing the canine waste using a strap.

### (h) BRIEF SUMMARY OF THE INVENTION

An embodiment of the disclosure meets the needs presented above by generally comprising a base being a quilted pad. The base has a top surface, a bottom surface, and a ring positioned on a perimeter edge of the base. The ring is hollow and has a pair of openings to an interior of the ring. Furthermore, a strip is positioned on the bottom surface of the base and is an adhesive material. A strap is nested within the ring of the base and is positioned within each of the openings wherein defining a pair of grips.

Another embodiment of the disclosure includes a method comprising a step of removing a peel from a strip of a bottom surface of a base and fastening the strip on a ground surface. Subsequent to a canine waste being produced upon the base, the user pulls on a pair of grips of a strap of the base and encloses the canine waste within a top surface of the base with the strap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a canine portable bathroom pad device and method according to an embodiment of the disclosure.

FIG. 2 is a bottom view of an embodiment of the disclosure.

FIG. 3 is a top view of an embodiment of the disclosure.

FIG. 4 is a cross-sectional view of an embodiment of the disclosure taken from FIG. 3 of Line 4-4.

FIG. 5 is an in-use view of an embodiment of the disclosure.

### (j) DETAILED DESCRIPTION OF THE INVENTION

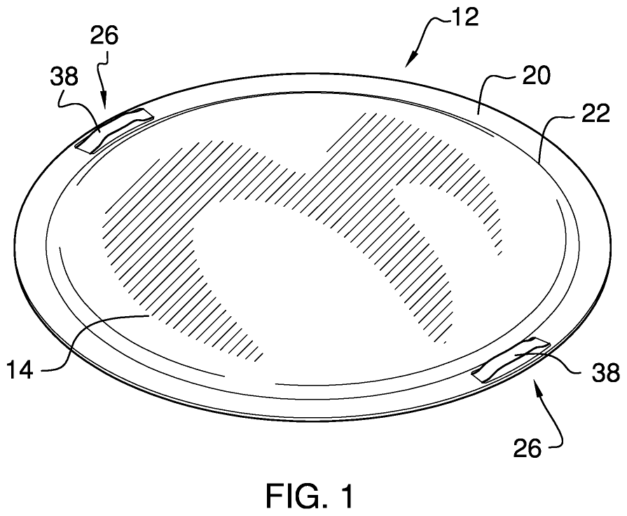

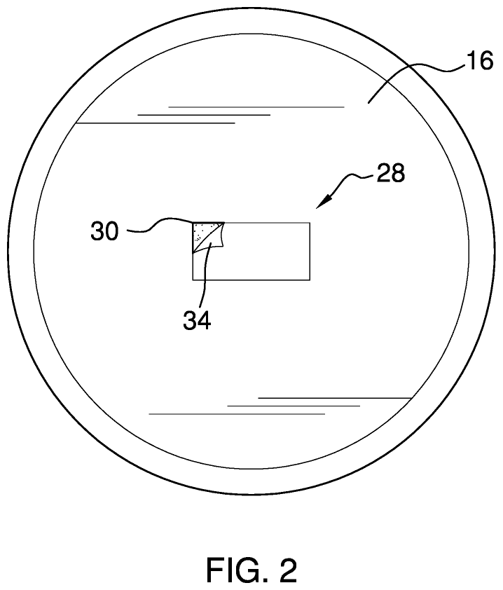

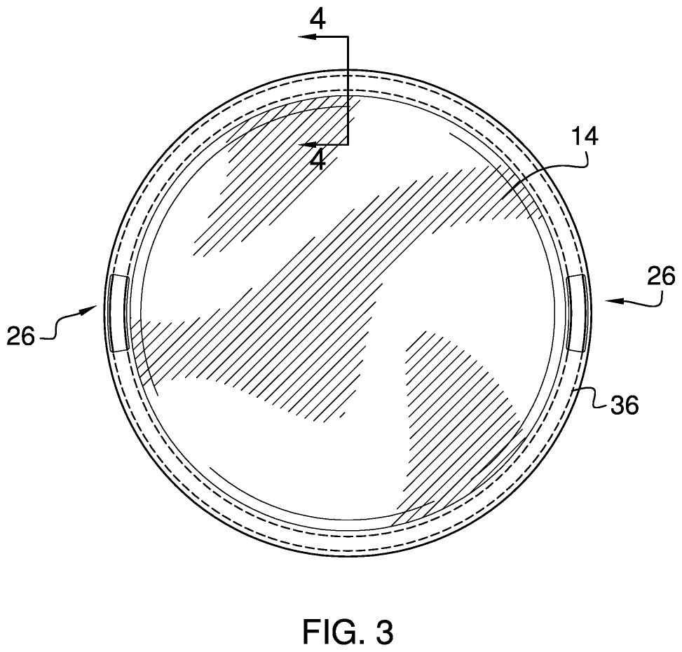

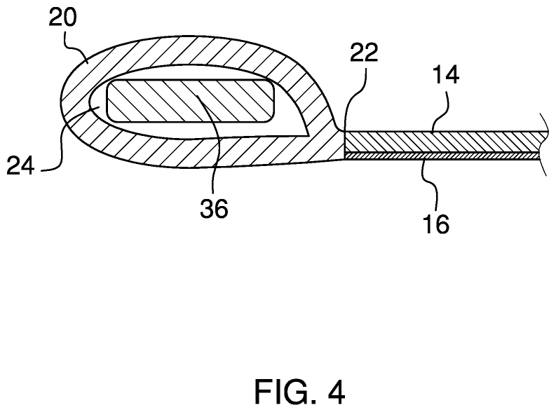

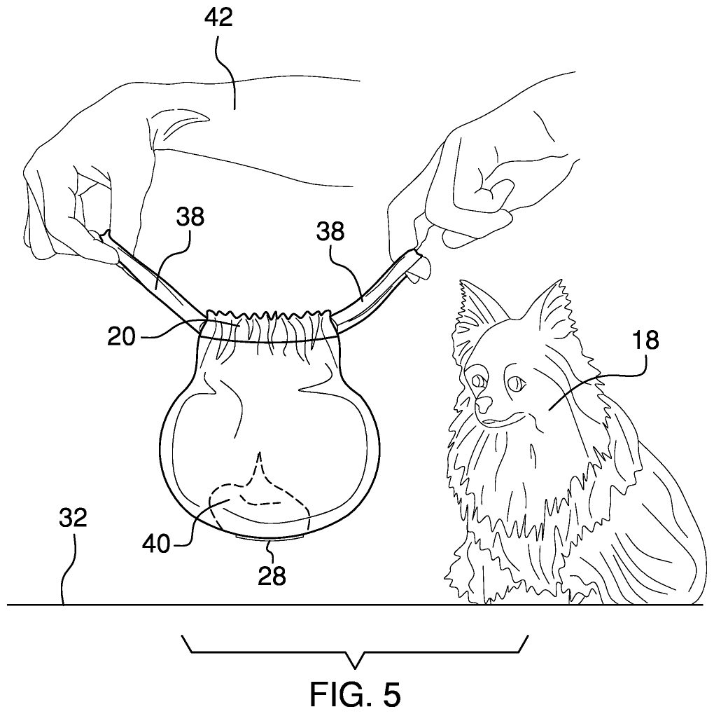

With reference now to the drawings, and in particular to FIGS. 1 through 5 thereof, a new portable trash device embodying the principles and concepts of an embodiment of the disclosure and generally designated by the reference numeral 10 will be described.

As best illustrated in FIGS. 1 through 5, the canine portable bathroom pad device and method 10 generally comprises a base 12. The base 12 is a quilted pad being circular in shape and includes a top surface 14 and a bottom surface 16. The top surface 14 of the base 12 is liquid absorbent wherein retaining liquid from a canine 18.

Alternately, the bottom surface 16 of the base 12 is liquid impervious wherein obstructing liquid from passing through thus preventing leakage. Additionally, the base 12 has a ring being a supple material configured for being compressible. The ring 20 is positioned on a perimeter edge 22 of the base 12 and is hollow in structure thus defining an interior 24 of the ring 20. In addition, the ring 20 has a pair of openings 26 for an interior 24 of the ring 20 with each of the openings 26 being positioned facing the top surface 14 of the base 12.

A strip 28 is positioned on the bottom surface 16 of the base 12. The strip 28 is an adhesive material 30 being configured for being able to retain to a ground surface 32 with a semi-strength hold. The strip 28 can be removed from the ground surface 32 by pulling on the base 12 with enough force to release the adhesive material 30 from the ground surface 32. The strip 28 has a rectangular shape and includes a peel 34 being positioned on the strip 28. The peel 34 is used to prevent the strip 28 from fastening to unwanted surfaces prior to use. The peel 34 is removable from the strip 28 wherein exposing the strip 28 for fastening the base 12 to the ground surface 32 when in-use.

A strap 36 is nested within the interior 24 of the ring 20 of the base 12. The strap 36 is circular and fills the entirety of the interior 24 of the ring 20. Furthermore, the strap 36 is positioned within each of the openings 26 of the ring 20 to define a pair of grips 38. Each of the grips 38 is configured for being pulled wherein tightening the strap 36 and compressing the ring 20 thus enclosing the top surface 14 within itself. The strap 36 can be tied in a knot to secure a canine waste 40 upon the top surface 14 of the base 12.

In use, the user 42 removes the peel 34 from the strip 28 of the bottom surface 16 of the base 12 and fastens the strip 28 on the ground surface 32. Subsequent to the canine waste 40 being produced upon the top surface 14 of the base 12, the user 42 pulls on the pair of grips 38 of the strap 36 of the ring 20 and encloses the canine waste 40 within the top surface 14 of the base 12 by enclosing the ring 20. The user 42 removes the strip 28 from the ground surface 32 by pulling on the base 12 with enough force to release the adhesive material 30 from the ground surface 32. The pair of grips 38 can be tied into a knot to secure the canine waste 40 within the base 12 prior to being disposed of.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A canine portable bathroom pad device configured for adhering to the ground when in user, the canine portable bathroom pad device comprising:
a base being a quilted pad, the base having a top surface and a bottom surface, the base having a ring, the ring being positioned on a perimeter edge of the base, the ring being hollow, the ring having a pair of openings to an interior of the ring;
a strip being positioned on the bottom surface of the base, the strip being an adhesive material; and
a strap being nested within the ring of the base, the strap being positioned within each of the openings wherein defining a pair of grips.

2. The canine portable bathroom pad device of claim 1, further comprising the base being circular.

3. The canine portable bathroom pad device of claim 1, further comprising the top surface of the base being liquid absorbent wherein retaining liquid.

4. The canine portable bathroom pad device of claim 3, further comprising the bottom surface of the base being liquid impervious wherein obstructing liquid from passing through.

5. The canine portable bathroom pad device of claim 1, further comprising the ring being a supple material.

6. The canine portable bathroom pad device of claim 1, further comprising each of the openings being positioned facing the top surface of the base.

7. The canine portable bathroom pad device of claim 1, further comprising the adhesive material being configured for being able to retain to a ground surface with a semi-strength hold.

8. The canine portable bathroom pad device of claim 1, further comprising the strip having a peel, the peel being positioned on the strip.

9. The canine portable bathroom pad device of claim 8, further comprising the peel being removable from the strip wherein exposing the strip.

10. The canine portable bathroom pad device of claim 2, further comprising the strap being circular.

11. The canine portable bathroom pad device of claim 5, further comprising each of the grips being configured for being pulled wherein compressing the ring.

12. A canine portable bathroom pad device configured for adhering to the ground when in user, the canine portable bathroom pad device comprising:
a base being a quilted pad, the base being circular, the base having a top surface and a bottom surface, the top surface of the base being liquid absorbent wherein retaining liquid, the bottom surface of the base being liquid impervious wherein obstructing liquid from passing through, the base having a ring, the ring being a supple material, the ring being positioned on a perimeter edge of the base, the ring being hollow, ring having a pair of openings to an interior of the ring, each of the openings being positioned facing the top surface of the base;
a strip being positioned on the bottom surface of the base, the strip being an adhesive material, the adhesive material being configured for being able to retain to a ground surface with a semi-strength hold, the strip having a peel, the peel being positioned on the strip, the peel being removable from the strip wherein exposing the strip; and
a strap being nested within the ring of the base, the strap being circular, the strap being positioned within each of the openings wherein defining a pair of grips, each of the grips being configured for being pulled wherein compressing the ring.

13. A method for using a portable bathroom pad for a canine, the method comprising a step of:
removing a peel from a strip of a bottom surface of a base;
fastening the strip on a ground surface;
pulling on a pair of grips of a strap of the base; and
enclosing a canine waste within a top surface of the base with the strap.
